(19) United States
(12) Patent Application Publication
(10) Pub. No.: US 2008/0285134 A1
(43) Pub. Date: Nov. 20, 2008

(54) Automotive Glazing with Selective Diffusion

(75) Inventors: Francois Closset, Jumet (BE); Nerio Lucca, Jumet (BE); Etienne Degand, Jumet (BE)

Correspondence Address: AKERMAN SENTERFITT, P.O. BOX 3188, WEST PALM BEACH, FL, 33402-3188, US

(73) Assignee: AGC Flat Glass Europe, Jumet (BE)

(21) Appl. No.: 11/908,154

(22) PCT Filed: Mar. 9, 2006
(86) PCT No.: PCT/EP2006/060582

§ 371 Date: Apr. 9, 2008

(30) Foreign Application Priority Data
Mar. 10, 2005 (BE) 2005/0128

(51) Int. Cl. G02B 27/00

(52) U.S. Cl. 359/601

(57) ABSTRACT

Automotive glazing which can diffuse light in a distinct manner depending on the angle of incidence thereof on the glazing, whereby a first incidence angle range corresponds to diffusion of at least 30% of the light and a second incidence angle range corresponds to diffusion of less than 10%.

The present invention relates to motor vehicle glazing and in particular windscreens.

Traditional motor vehicle glazing, whether simple or laminated, has a wide variety of optical properties. It is, in particular, chosen as a function of its light transmission qualities. It is also chosen in some cases, for the selectivity that it offers in the transmission of radiation in order to filter, for example, infrared and/or ultraviolet rays.

One object of the invention is to propose motor vehicle glazing having a selective light scattering along the angle of incidence of the rays on this glazing. Another subject of the invention is to propose improved anti-reflective motor vehicle glazing. A further object of the invention is to propose motor vehicle glazing which also offers a certain protection against the greenhouse effect during exposure to the sun.

According to the invention, the motor vehicle glazing considered is such that it has the property of scattering a very large part of these rays when they are in a first angle of incidence domain, and of only having a low scattering of these same rays when they are outside of the scattering incidence domain. In the high-scattering domain this is greater than 30% of the incident light. In the low-scattering domain, it remains less than 10%.

In order to obtain this selective scattering, various means can be envisaged. It is possible to ensure that the effect results directly from the structure of a glass sheet. It is also possible to form the glazing by combining at least one glass sheet with a sheet of a material having the properties indicated. By way of simplification, in the following reference is made to glazing corresponding to this combination of at least one glass sheet and one sheet of material having this selective scattering property along the angle of incidence of the light rays.

The sheets of materials that offer this selective scattering as a function of the angle of incidence of the light are known, for example, from U.S. Pat. No. 4,929,523. These sheets are especially composed of a material whose refractive index is not uniform over the whole surface. The sheet generally comprises alternate zones of high index and of lower index. These zones are distributed in approximately regular manner along one and the same direction.

The sheets of these materials have been proposed and used mainly for applications in the building industry. They are used with glass sheets, for example, for forming walls that offer, along certain angles, a high transparency and along other angles a simple translucency keeping a “private” character for the space delimited by these walls. They are also proposed for improving the lighting of places by reflecting the incident radiation in directions not reached by the light directly transmitted when ordinary glazing is used.

The structure of these sheets of material with selective scattering and their advantageous properties in motor vehicle use are presented in the remainder of the description with reference to the appended drawings in which:

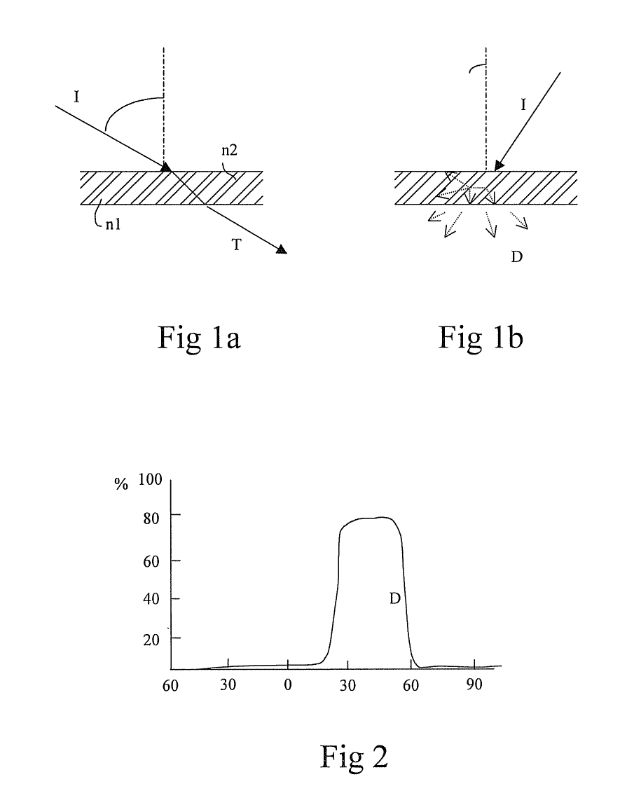

FIGS. 1a and 1b represent a schematic cross-sectional view of the structure of a sheet of material having selective transmission that is incorporated, according to the invention, in the composition of motor vehicle glazing;

FIG. 2 is a graph representing the light scattering variations of a sheet of material such as represented in FIGS. 1a and 1b;

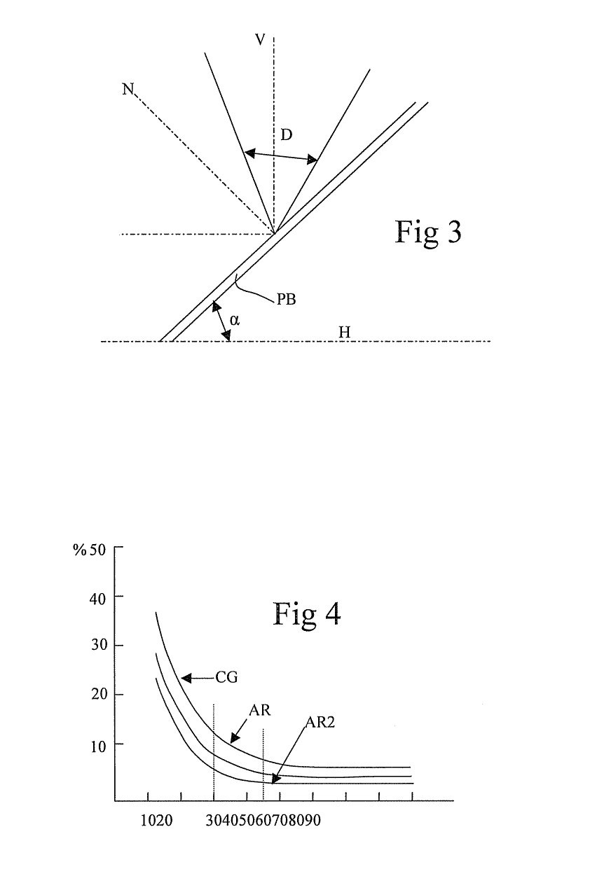

FIG. 3 represents a schematic cross-sectional view of a windscreen formed with glazing of which the properties are those indicated in FIG. 3;

FIG. 4 is a graph showing the incidence of the angle of inclination of glazing on the reflection;

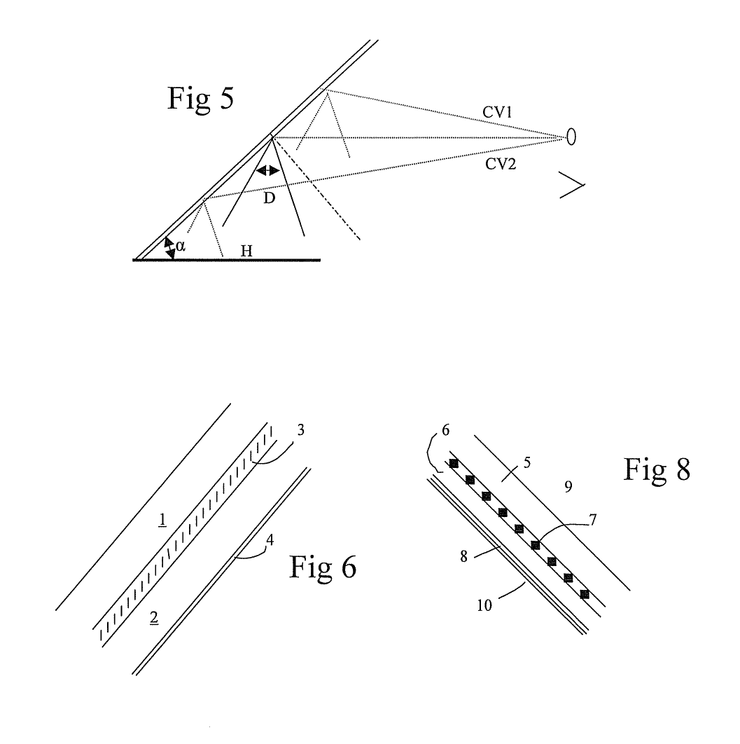

FIG. 5 illustrates the anti-reflective properties of glazing according to the invention used as a motor vehicle windscreen;

FIG. 6 is a partial schematic cross-sectional view of a windscreen according to the invention;

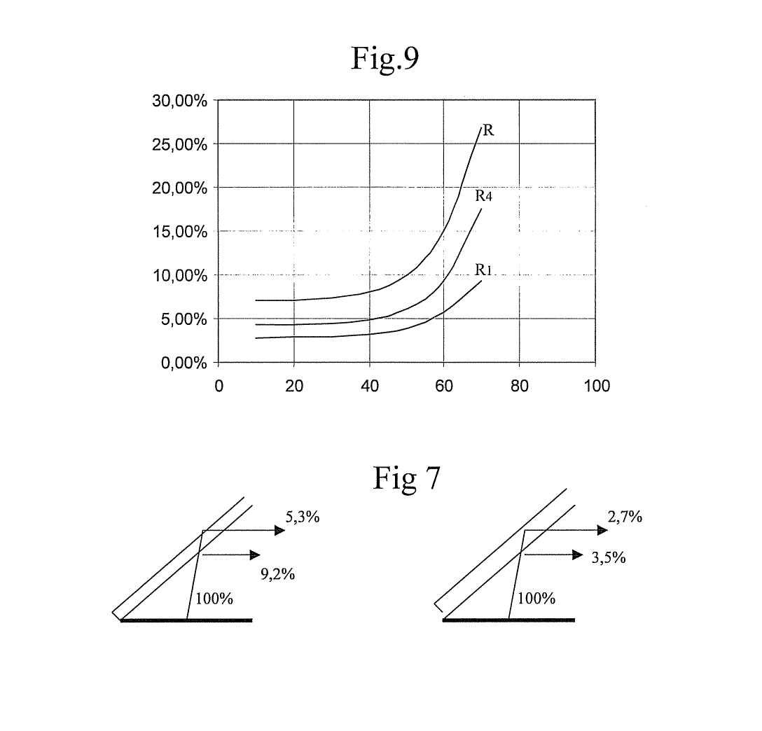

FIG. 7 illustrates the anti-reflective properties obtained using glazing according to the invention as a windscreen;

FIG. 8 represents a partial cross-sectional view of a rear window according to the invention; and

FIG. 9 is a graph presenting the components of the reflection as a function of the angle of incidence on glazing.

The operating principle of the sheets with direct selective scattering/transmission along the angle of incidence is represented schematically in FIGS. 1a and 1b. Other structures are capable of producing similar properties. By way of simplification however, reference is made in the following to these commercially-available sheets. They are produced, in particular, by Sumitomo Chemicals under the name “Lumisty”.

The sheet presented in cross-sectional view is, in an idealized manner, composed of successive strata inclined relative to the plane of the sheet. The structure is in fact less regular than that which is shown, but overall their behaviour is that of these structures. Schematically, two types of strata corresponding to two separate indices n₁ and n₂ are regularly positioned in the thickness of the sheet. In a known manner, these sheets are obtained, for example, from a material polymerized in a distinct manner along the zones concerned. The polymerization is carried out, for example, by exposure of one series only of these strata to actinic rays during the polymerization. These conditions result in polymers with distinct molecular weights or with different degrees of crosslinking, that consequently have different indices.

In FIGS. 1a and 1b, the strata are inclined relative to the faces of the sheet. This inclination and also the respective thickness of each stratum and the differences in the index between the two types of strata condition the operation of these sheets with respect to the incident rays.

FIG. 1a shows, taking into account the configuration, an incident ray I penetrating under a relatively large angle with respect to the surface of the sheet, but which spreads and encounters the strata of index n₂ along an angle close to the normal to these strata taking into account their arrangement in the sheet. As a function of this incidence relative to the strata of index n₂, the ray is transmitted practically in full with a negligible deviation. Overall, with respect to the incident ray I, the sheet behaves as a dioptre with parallel sides having an index that is little different from n₁. The transmitted ray T is of the same direction as the incident ray I, and its intensity is reduced only due to the reflection that takes place on the faces of the sheet and the absorption within it, which, so long as the incidence is not too low-angled and the material is not very absorbent, remain small-scale. In other words the light transmission factor (LT) may be kept relatively high. Scattering is practically nonexistent.

FIG. 1b for the same material illustrates the behaviour of an incident ray of which the direction is close to that of the strata in the sheet. In this configuration, the ray is dispersed by means of multiple reflections and diffractions that overall lead to a scattering S which may be quantified as “haze”.

Measurement of this scattering denotes the ratio of the intensity of the dispersed light to that of the incident light. The measurement is carried out according to the standard ASTM D 1003.

FIG. 2 is a graph which represents the fraction of incident light scattered as a function of the angle of incidence. The glazing for this example is composed of two clear “float” glass sheets each with a thickness of 2 mm, combined with an intermediate sheet comprising a sheet with selective scattering/direct transmission. On this graph, the x-axis indicates the angle in degrees relative to the normal to the sheet, and the y-axis the percentage of light scattered for a material with typical selective transmission as shown in FIG. 1.

The inclination of the strata with respect to the normal to the sheet is in this example around 45 degrees. On both sides of an angle of 45 degrees an angular domain is found for which scattering represents around 80% of the incident light. In the example represented, starting from the normal to the sheet, on an angular domain extending from around 25 to around 55 degrees, the scattering represents more than 50% of the incident light. In this domain, the direct transmission is very much reduced and the material appears translucent. Conversely, below 20 degrees and above 65 degrees scattering disappears almost completely. The material offers a higher direct transmission. It appears transparent to the observer located behind the sheet.

The sheets having these selective scattering/direct transmission properties that are commercially available offer various combinations, especially as regards the scattering domains. These domains are, for example, located in the angular intervals with respect to the normal to the sheet of 15 to 45 degrees, 35 to 65 degrees, 45 to 75 degrees and 55 to 90 degrees. For wider scattering domains, it is also possible to combine the effects of several superposed sheets. In this case, the scattering domains add up. The manufacturers propose sheets whose scattering domains are for example −25 to 25 degrees or else 0 to 55 degrees. These examples are not limiting.

It is therefore possible to choose the angle domains in which the high scattering lies and those in which this scattering is very limited, in order to meet the requirements of the envisaged use.

In the example represented in FIG. 2, outside the domain of high scattering (25 to 55 degrees taken from the normal), the direct transmission is at the highest. It is practically that of the assembled glass sheets. For the clear glass sheets it is established at more than 80%.

Generally, the glazing according to the invention has domains in which the scattering exceeds 30% of the incident light, and preferably in which the scattering is greater than 50% and even greater than 70% of the incident light. These domains of very high scattering extend over an angle of at least 10 degrees, and preferably over an angle of at least 15 or even 20 degrees. These domains preferably do not exceed an angle of 90 degrees.

The glazing according to the invention simultaneously has, for the incident light, domains in which the scattering is practically nonexistent. In these domains, the scattering preferably does not exceed 5%, and even more preferably remains less than 2%. These domains are supplementary to the preceding ones. They are often split into two parts on both sides of a high-scattering domain. Overall, the low-scattering domains cover an angle of at least 30 degrees and preferably at least 60 degrees or even 90 degrees.

Transition zones lie between the high-scattering and low-scattering domains. FIG. 2, which represents a typical form of behaviour of glazing according to the invention, shows that the transition is ordinarily very rapid. The passage from one zone to the other extends over an angle of about 10 degrees.

The properties explained previously are benefited from according to the invention in the application to motor vehicle glazing, especially to the glazing that has, once installed, a very high inclination with respect to the vertical. These conditions are found more and more in modern vehicles, in particular for windscreens, and sometimes also for the rear windows, which poses numerous problems in terms of, for example, thermal comfort or the appearance of reflections that disturb the vision of the driver.

The implementation of the invention is explained in detail in the remainder of the description with respect to windscreens, but this presentation is not limiting. The invention relates to all motor vehicle applications of glazing with selective scattering/direct transmission as a function of the angle of incidence of the light.

The case of windscreens as indicated is particularly affecting in so far, due to development, as their inclination is increasingly high on the one hand, and on the other hand owing to the regulatory constraints which they must meet. Among these, the requirements in terms of light transmission appear in particular.

FIG. 3 illustrates the use, as a windscreen, of glazing offering the properties reproduced in FIG. 2.

The windscreen (WS) is shown with an inclination relative to the horizontal (H) of around 45 degrees (α). In this configuration the domain of very high scattering angle (S), located between about 25 and 55 degrees relative to the normal (N) to the windscreen, leaves a large angular domain covering the visual field of the driver perfectly free from scattering.

This inclination of 45 degrees is quite common for current private vehicles. In fact, the majority of windscreens have, once installed, an inclination between 20 and 45 degrees. The presentation made with regard to this FIG. 3, may be reproduced for the whole of this inclination domain. The domains of angles of incidence in this case are only offset in rotation to take into account the angle α effectively chosen. It is also possible to choose a sheet whose characteristics with regards to transmission are different from those indicated here, so as to obtain the best possible selectivity as a function of the incidence corresponding to the chosen inclination.

In FIG. 3, it can be seen that the domain of incidence corresponding to the maximum scattering comprises the vertical direction (V). In other words, this arrangement offers the advantage of blocking the direct transmission of the most active solar rays, those corresponding to the sun at its zenith. In particular, this arrangement reflects, in scattered form, a significant part of the radiation received under this vertical incidence. The scattering is especially carried out in part towards the outside therefore limiting the energy penetrating into the passenger compartment of the vehicle. The use of glazing conforming to the invention consequently contributes to the limitation of the “greenhouse effect” drawbacks linked to the presence of very inclined glazing.

In compensation, it is true that the vision through the glazing under very “vertical” incidences reveals a translucent appearance. This appearance is however not bothersome, being, for the vehicle passengers, a quite unusual viewing angle. Seen from the outside, this particularity is even less troublesome as viewing from above is even less common. Furthermore, the use of coloured glass, which is normal for this glazing, further minimizes the perception of this appearance.

In any case, the important thing is of course to preserve the direct light transmission and to limit scattering in the visual field of the driver and of the passengers of the vehicle. The main part of this visual field is necessarily in accordance with the current regulations. According to these regulations, for the windscreen, the light transmission measured perpendicularly to the glazing must be at least 75% in Europe and 70% in the USA.

In the case represented, it is observed that the normal to the glazing is outside of the zone corresponding to the high scattering. This high-scattering domain is itself far from the normal to the windscreen. In other words, along the normal direction, the scattering is practically non-existent and the transmission is practically that of a similar glazing that does not comprise a sheet with selective scattering. The transmission is very high and practically without haze (less than 2%, and even preferably less than 1% of the incident light).

The comparison of the regulatory conditions with the domains of angles of incidence of the windscreens formed according to the invention, offering a light transmission practically without scattering, shows that these conditions are perfectly satisfactory and much more.

One particularly advantageous property of the glazing according to the invention is making it possible to reduce the bothersome reflections and, especially, those which appear on the windscreens and superpose images that interfere with that observed through the windscreen.

The interference images observed are those that are generated by the parts of the passenger compartment which emit or reflect light radiation under an incidence such that one part at least is reflected into the viewing zone of the driver.

Taking into account the position of the driver, only one part of the elements of the passenger compartment may generate these reflected images. In this phenomenon, the inclination of the windscreen plays a very important part. The current tendency is to have increasingly inclined windscreens, with at the same time an increase in the dimensions of the dashboard facing the windscreen. These conditions favour the appearance of the image of the dashboard reflected in the visual field of the driver.

FIG. 4 represents the reflection part of the incident light, measured as a function of the angle of inclination relative to the plane of the sheet, from a low angle up to the normal to the sheet (90 degrees) shown on the x-axis. A first curve corresponds to a clear glass sheet with a thickness of 4 mm, and which does not comprise any functional particularity. On the corresponding curve (CG) it is observed that for the preferred domain of inclination of the windscreens from 45 to 30 degrees, the reflection part passes from around 8 to around 14.5%. In the two cases, the reflection is too high to prevent perception of the corresponding interference images.

FIG. 4 also shows the reflection measurement for a glass similar to the previous one but on which a set of anti-reflective layers is arranged on one side (for the windscreen, the side facing the inside of the passenger compartment). By suitably choosing the layers in question, in this particular case a set comprising two superposed layers having alternate high and low indices, the reflection may be reduced by around half (curve AR).

The sets of suitable layers are, for example:
glass/Sno₂(60 Å)/SiO₂(1150 Å);
   or more complex systems such as:
glass/TiO₂(130 Å)/SiO₂(390 Å)/TiO₂(130 Å)/SiO₂(920 Å).
   With the first of these layers, the reflection is established respectively for the same inclinations of 45 and 30 degrees, at around 6 and 8%. Although reduced, these reflection values are still too high.

To prevent the vision of the driver being disturbed by the interference images, the manufacturers endeavour to limit the light capable of being reflected, and choose to form dark-coloured dashboards that are made from matt materials. This situation is not satisfactory, and the manufacturers desire to be free of this constraint, especially for providing light-coloured interiors. For this, they must be able to use a windscreen having further improved anti-reflection properties.

The solution consisting in using anti-reflection layers on the two outer faces effectively results in levels of reflection of less than 5%, even for the highest inclinations (curve AR2 on the graph from FIG. 4). But the use of anti-reflection layers in windscreens can only affect the face turned towards the passenger compartment.

The anti-reflection layers are actually normally obtained by vacuum deposition techniques, especially by magnetron sputtering. These layers are relatively fragile. Turned towards the passenger compartment, they are not subjected to very rigorous mechanical stresses. Conversely, the treatment of the outer face, which must withstand repeated wear trials, especially due to the sweeping by the windscreen wipers, cannot be envisaged. For this reason, in practice, the application of anti-reflective layers is limited to the inner face, and its effect is insufficient to prevent the presence of these interference images, especially those that stem from the reflection at the outer interface of the glazing (face 1).

One of the objects of the invention is to provide “anti-reflective” glazing formed from glass sheets combined with a sheet with selective scattering/transmission as a function of the incidence of the light.

FIG. 5 schematically represents the “anti-reflection” operation of a windscreen made from glazing according to the invention. In this figure the dashboard is represented by the horizontal line H.

The light penetrating into the passenger compartment reflected by the dashboard is partly reflected on the faces of the windscreen and is found in the visual field of the driver arbitrarily represented by the lines CV1 and CV2. The presence of a sheet with selective scattering, such as that whose characteristics are illustrated in FIG. 2, results, on both sides of this sheet, in incidences for which the radiation is scattered. The angular domain corresponding to the maximum scattering for the light coming from the passenger compartment is indicated S on the horizontal of the visual field. Corresponding to this domain is that in which the radiation from the passenger compartment is “de-reflected”. The limits of the domain of the scattered radiation are shown as a dotted line at the ends of the visual field. It is observed that it practically encompasses the whole of the dashboard so that the appearance of reflective images is very limited.

The preceding representation corresponds to that for which the sheet with selective scattering is located first in the path of the light coming from the dashboard. In practice, the windscreens must have a laminated structure, a first reflection takes place on the inner glass face of the windscreen. For this reflected part, the sheet with selective transmission located between the two glass sheets is not involved. In order to obtain an improved anti-reflective effect it is therefore necessary to also use an anti-reflective layer of the type indicated previously on the inner face of the windscreen as shown in FIG. 6.

The cross section of the glazing forming the windscreen comprises, from the outside towards the inside of the passenger compartment:
a first glass sheet (1) which may especially bear layers reflecting infrared rays in a known manner, or a conductive layer;
an intermediate plastic sheet (3) connecting the two glass sheets, this sheet including a sheet with selective transmission properties along the incidence of the rays, optionally combined with sheets traditionally used to form laminated glazing; and
a second glass sheet (2) turned towards the passenger compartment, coated on the face turned towards the inside with a set of anti-reflective layers (4).

FIG. 7 illustrates the results obtained with glazing according to the invention comprising an intermediate sheet that comprises a sheet with selective scattering/direct transmission as a function of the incidence, and with conventional glazing that only comprises an isotropic intermediate sheet, in this case a simple sheet of polyvinyl butyral.

In the example represented, the windscreen is formed from two “float” glass sheets each with a thickness of 2 mm, one sheet of clear glass and the other of slightly green-tinted glass. The inclination chosen is 30 degrees relative to the horizontal in both cases.

Starting from a value of light intensity arbitrarily denoted as 100% emitted from the dashboard, the conventional laminated glazing reflects 9.2% onto the inner face of the windscreen (face 4). A second large reflection occurs on the outer interface (face 1) and reflects an intensity of 5.3%.

The object of the invention is to scatter a significant part of this reflection, its incidence on the glazing being in the high-scattering domain. The consequence of this scattering being a significant decrease in the optical disturbance caused by the reflection of the dashboard in the viewing field of the driver.

The windscreen according to the invention also comprises an anti-reflective layer on face 4. The values reflected towards the inside of the vehicle respectively on the faces 4 and 1 are then 3.5% and 2.7%. The total reflected light is finally reduced practically by half.

By way of indication, the values of the components of the reflection obtained on laminated glazing composed of two clear glass sheets free of anti-reflective layers, and assembled with a sheet of polyvinyl butyral, are given as a function of the angles of incidence measured from the normal to the sheet. The total reflection R is the sum of the partial reflections on the faces 1 and 4, reflections respectively denoted by R₁ and R₄. In this representation, the light comes from the inside, is partly reflected on the face 4 and in a more limited way on the face 1.

In the glazing according to the invention, the scattering-selective sheet may only cover one part alone of the glass sheet or sheets with which this sheet is combined. This limitation may be preferred, in particular, for cost reasons when the application does not require that the whole of the glazing offers these properties. One particular application of this arrangement relates to the glazing which is used for forming reflected images which are superposed on that perceived by simple transparency.

This type of glazing is used for the display of information intended, for example, for the driver in devices known as “head-up” devices. In this glazing, contrary to the preceding example, the reflection on the windscreen is deliberately made for information projected onto the windscreen. The means used have the drawback of resulting in a double image due to the two air/glass interfaces. The two reflections are not of the same intensity. The strongest is that formed on the inner face (face 4) of the windscreen. The introduction of a sheet with selective scattering between the two glass sheets, optionally located in a limited manner in the zone intended to reveal the reflected images, makes it possible to further reduce the second reflection considerably, and to make this double image practically disappear.

The glazing according to the invention which comprises a sheet with selective scattering/direct transmission may comprise other functional, advantageously combined, elements. As indicated previously, the presence of a sheet with selective scattering/transmission may, by the choice of suitable domains, minimize the direct transmission of the light incident at its zenith. The scattering in this case may result in the absorption of some of the high-energy rays. In order to obtain an intense solar-protection effect, it is known to use layers that reflect a high proportion of the infrared radiation. These layers are especially those comprising one or more thin metallic layers. One combination according to the invention consists, for example, in forming a laminated glazing of which the first glass sheet, starting from the outside of the vehicle, comprises such a layer reflecting the infrared radiation, an intermediate sheet, or a set of intermediate sheets, comprising one sheet with selective scattering/direct transmission, and a second glass sheet optionally provided on the inner face, with a set of anti-reflective layers.

The solar-protection glazing is especially qualified by its “solar factor” (SF) which is the percentage of energy penetrating through the glazing relative to the incident solar energy. The energy penetrating is composed of that directly transmitted and of the part of the energy absorbed by the glazing and re-admitted towards the inside. Advantageously, the glass sheet comprising a solar-protection assembly, has a solar factor less than 60% (measured according to the standard EN 410), while retaining a light transmission which is not less than 80%.

Outside of laminated glazing, especially windscreens, the invention also targets assemblies which only comprise a single glass sheet. This arrangement can be applied, in particular, to rear windows. FIG. 8 represents this type of use.

The representation is that in which the window is composed of a toughened glass sheet (5), comprising a sheet with selective scattering/transmission (6) positioned on the face turned towards the passenger compartment.

As a general rule, the glass sheet (5) comprises a network of heating wires 7 intended to demist or de-ice the window.

The sheet with selective scattering/transmission may be applied directly to the glass sheet or comprise an adhesive (9). Since this sheet often has an insufficient hardness to protect it especially against scratches, it is advantageously covered by a stronger film, for example a film (8) of polyethylene terephthalate glycol (PET). As for the windscreens, the rear window, in order to have the best anti-reflection property is further coated on its inner face with an anti-reflective layer (10) conventionally applied to the PET sheet.

1. Motor vehicle glazing which has the property of scattering light in a distinct manner along the angle of incidence of the light on the glazing, a first angle of incidence domain corresponding to a scattering of at least 30% of the light, and a second angle of incidence domain corresponding to less than 10% scattering.

2. Motor vehicle glazing according to claim 1, comprising at least one glass sheet and associated with it, a sheet of material giving it its properties of selective scattering along the angle of incidence of the light.

3. Glazing according to claim 1, in which, in the angle of incidence domain for which the scattering is low, this scattering is not greater than 5% and preferably less than 2%.

4. Glazing according to claim 1, in which, in the domain of high scattering, more than 30%, and preferably more than 70% of the light is scattered.

5. Glazing according to claim 1, in which the high scattering extends over an angle of incidence domain which is not less than an angle of 10 degrees, and preferably not less than an angle of 20 degrees.

6. Glazing according to claim 1, in which the zone of scattering greater than 5% does not extend over an angle of incidence domain greater than an angle of 90 degrees.

7. Glazing according to claim 1, in which the domain of scattering below 5% extends over an angle of at least 30 degrees and preferably an angle of 90 degrees.

8. Glazing according to claim 1, in which, when the glazing is installed in the motor vehicle, the domain of low-scattering angle, in a vertical plane approximately perpendicular to the plane of the glazing, extends on both sides of the horizontal.

9. Glazing according to claim 1, in which, when the glazing is installed in the motor vehicle, the domain of high-scattering angle, in a vertical plane approximately perpendicular to the plane of the glazing, extends on both sides of the vertical.

10. Glazing according to claim 2, comprising two glass sheets assembled in laminated form using an intermediate sheet comprising the sheet of material of which the light scattering depends on the angle of incidence.

11. Glazing according to claim 10, in which the intermediate sheet comprises, in addition to the sheet of material of which the light scattering depends on the incidence, at least one intermediate sheet traditionally used for forming laminated glazing.

12. Glazing according to claim 10, which is moreover coated on the side turned towards the inside of the vehicle with an anti-reflective thin layer.

13. Glazing according to claim 12, in which the anti-reflective layer comprises, starting from the glass sheet, a succession of layers having an alternately high and low index.

14. Glazing according to claim 1, forming a motor vehicle windscreen.

15. Motor vehicle glazing according to claim 2, in which the sheet, of which the scattering depends on the angle of incidence of the light, only covers some of the surface of the glass sheet.

16. Glazing according to claim 1, in which the glass sheet is a glass sheet whose solar factor (SF) according to the standard (EN 410) is at most 60% while retaining a light transmission which is not less than 80% under a thickness of 4 mm.

17. Glazing according to claim 1, in which the glass sheet comprises a set of thin layers having infrared-reflective properties.

18. Glazing according to claim 15, in which the sheet of which the scattering depends on the angle of incidence is located in the zone of the windscreen intended for reflecting images of the HUD type.

19. Glazing according to claim 1, forming a motor vehicle rear window.
